(19) United States
(12) Patent Application Publication
(10) Pub. No.: US 2013/0086187 A1
(43) Pub. Date: Apr. 4, 2013

(54) SYSTEM AND METHOD FOR INDICATING VALID SENDER

(71) Applicant: ACTIVEPATH LTD., Petah-Tiqva (IL)

(72) Inventors: Ram COHEN, Tel Aviv (IL); Aryeh MERGI, Bazra (IL)

(73) Assignee: ACTIVEPATH LTD., Petah-Tiqva (IL)

(21) Appl. No.: 13/628,992

(22) Filed: Sep. 27, 2012

Related U.S. Application Data
(60) Provisional application No. 61/542,820, filed on Oct. 4, 2011.

(51) Int. Cl. G06F 15/16

(52) U.S. Cl. 709/206

(57) ABSTRACT

Systems, methods, computer program products, and networks for messaging. An example of a method includes outputting a receiver specific indication of validation to a receiver of a message if a sender of the message has been validated. In this example data regarding the receiver specific indication was selected prior to the outputting, the selected data including data associated with the receiver on a website of the sender.

### CROSS REFERENCE TO RELATED APPLICATIONS

This application claims the benefit of U.S. Provisional No. 61/542,820, filed Oct. 4, 2011, which is hereby incorporated by reference herein.

### TECHNICAL FIELD

The presently disclosed subject matter relates to the field of messaging.

### BACKGROUND

Messaging is widely used for communicating information between senders and receivers. For instance, in the early days of the Internet, email messages were simply text. Nowadays, however, email messages are typically although not necessarily, written in Hyper Text Markup Language (HTML).

However, when the standards for communication protocols were defined, they did not take into account the possibility of a malicious sender trying to disguise his identity and sending malicious content that may damage the receiving system, steal information from the receiving system, and/or lure the receiver into providing sensitive information (such as his online banking credentials) to an unauthorized party.

There are several common standards that perform operations to ensure that the message sender and/or the message content may be trusted. For instance, digitally signing the message with standards such as Secure/Multipurpose Internet Mail Extensions S/MIME, DomainsKeys, Pretty Good Privacy PGP, or Domains Keys Identified Mail DKIM may help to ensure the identity of the sender and that the message content has not been altered after it has been signed by the sender. Other standards such as SPF (Sender Policy Framework) are meant to tackle the problem of spamming and phishing by ensuring that the sending server is associated with the proclaimed message sender.

However, the receiver is often unaware of any standards implemented in order to try to ensure the identity and validity of a message. Therefore, the receiver may not fully trust the message, even if message identity and validity have been verified by the standard(s). This lack of trust may lead both receivers and legitimate senders to limit their actions via the messaging channel.

### SUMMARY

In one aspect, in accordance with the disclosed subject matter there is provided a method of providing an indication that a sender has been validated, comprising: if a sender of a message has been validated, outputting to a receiver of the message a receiver specific indication of validation, wherein data regarding the receiver specific indication was selected prior to the outputting, the selected data including data associated with the receiver on a website of the sender.

In some embodiments of the method, the receiver specific indication is presented within an area where the message is being presented.

In some embodiments of the method, the receiver specific indication is presented adjacent to an area where the message is being presented.

In some embodiments of the method, the receiver specific indication is presented outside of an area where the message is being presented.

In some embodiments of the method, the receiver specific indication is presented in a message list area.

In some embodiments of the method, at least part of the receiver specific indication is outputted after the receiver places a mouse over a GUI element.

In some embodiments of the method, at least part of the receiver specific indication is outputted after the receiver clicks on a GUI element.

In some embodiments of the method, at least part of the selected data was selected automatically.

In some embodiments of the method, the receiver specific indication is also specific to the sender or to a group including the sender.

In some embodiments of the method, the selected data was selected from among a plurality of data associated with the receiver on the website of the sender.

In some embodiments of the method, the receiver specific indication is not known to the sender.

In some embodiments of the method, if the sender has instead not been validated, outputting to the receiver a negative indication, indicating non-validation.

In another aspect, in accordance with the disclosed subject matter there is provided a method of indicating a valid sender, comprising: selecting data regarding a receiver specific indication for indicating a valid sender, wherein the selected data includes data that is associated with the receiver on a website of the sender; storing a basis for the receiver specific indication; after a message has been sent by the sender to the receiver validating the sender; and outputting to the receiver the receiver specific indication.

In some embodiments of the method, the receiver specific indication is identical to the basis.

In some embodiments, the method further comprises: deriving the receiver specific indication, wherein the deriving includes: tailoring the basis to at least one selected from a group comprising: sender, sender group, message characteristic, geographic location of sender, geographic location of receiver, receiving user device, or receiving application.

In some embodiments, the method further comprises: deriving the receiver specific indication, wherein the deriving includes: adding at least one generic element.

In some embodiments of the method, the receiver specific indication is not known to the sender.

In some embodiments, at least part of the selected data the selected data is selected automatically.

In some embodiments, the method further comprises: providing notification of validation. In some of these embodiments, the notification is provided as part of the message.

In another aspect, in accordance with the disclosed subject matter there is provided a method of providing an indication that a sender has not been validated, comprising: if a sender of a message has not been validated, outputting to a receiver of the message a receiver specific negative indication, indicating non-validation.

In some embodiments of the method, the receiver specific negative indication is presented in at least one of the following: within an area where the message is being presented, adjacent to an area where the message is being presented, outside of an area where the message is being presented, or in a message list area.

In some embodiments of the method, at least part of the receiver specific negative indication is outputted after the receiver places a mouse over a GUI element, or after the receiver clicks on a GUI element.

In some embodiments of the method prior to the outputting, at least one of the following is provided: input received from the receiver regarding the receiver specific negative indication, or data automatically selected regarding the receiver specific negative indication.

In some embodiments of the method, the receiver specific negative indication is not known to the sender.

In another aspect, in accordance with the disclosed subject matter there is provided an indication provider system, comprising: at least one indication provision handler operable to cause a receiver specific indication of validation to be provided to a receiver of a message if a sender of the message has been validated; wherein data regarding the receiver specific indication was previously selected, the selected data including data associated with the receiver on a website of the sender.

In some embodiments of the system, the system includes at least one of the at least one indication provision handler, the system being an external service system.

In some embodiments of the system, the system includes at least one of the at least one indication provision handler, the system being a message managing system operable to provide web-based message management to a plurality of users including the receiver.

In some embodiments of the system, the system includes at least one of the at least one indication provision handler, the system being a receiving system which further comprises: a user output operable to output the receiver specific indication to the receiver. In some of these embodiments, the output is operable to output at least part of the receiver specific indication when the receiver places a mouse over a GUI element. In some of these embodiments, the output is operable to output at least part of the receiver specific indication when the receiver clicks on a GUI element.

In some embodiments of the system, at least one of the at least one indication provider handler is operable to cause the receiver specific indication to be presented in an area where the message is being presented.

In some embodiments of the system, at least one of the at least one indication provider handler is operable to cause the receiver specific indication to be presented adjacent to an area where the message is being presented.

In some embodiments of the system, at least one of the at least one indication provider handler is operable to cause the receiver specific indication to be presented outside of an area where the message is being presented.

In some embodiments of the system, at least one of the at least one indication provider handler is operable to cause the receiver specific indication to be presented in a message list area.

In another aspect, in accordance with the disclosed subject matter there is provided an indication basis establisher system, comprising: at least one indication handler operable to automatically select, or receive, selected data regarding a receiver specific indication that a sender has been validated, wherein the selected data includes data that is associated with the receiver on a website of the sender, and operable to establish a basis for the receiver specific indication.

In some embodiments of the system, the system includes at least one of the at least one indication handler, the system being a user device associated with the receiver.

In some embodiments of the system, the system includes at least one of the at least one indication handler, the system being an external service system.

In some embodiments of the system, the system includes at least one of the at least one indication handler, the system being a message managing system operable to provide web-based message management to a plurality of users including the receiver.

In another aspect, in accordance with the disclosed subject matter there is provided a computer program product comprising a computer useable medium having computer readable program code embodied therein for providing an indication that a sender has been validated, the computer program product comprising: computer readable program code for causing the computer, if a sender of a message has been validated, to output to a receiver of the message a receiver specific indication of validation, wherein data regarding the receiver specific indication was selected prior to the output, the selected data including data associated with the receiver on a website of the sender.

In another aspect, in accordance with the disclosed subject matter there is provided a computer program product comprising a computer useable medium having computer readable program code embodied therein for indicating a valid sender, the computer program product comprising: computer readable program code for causing the computer to automatically select, or receive, selected data regarding a receiver specific indication for indicating a valid sender, wherein the selected data includes data that is associated with the receiver on a website of the sender; computer readable program code for causing the computer to store a basis for the receiver specific indication; computer readable program code for causing the computer, after a message has been sent by the sender to the receiver, to validate the sender; and computer readable program code for causing the computer to output to the receiver the receiver specific indication.

In another aspect, the disclosed subject matter provides a computer program product comprising a computer useable medium having computer readable program code embodied therein for providing an indication that a sender has not been validated, the computer program product comprising: computer readable program code for causing the computer, if a sender of a message has not been validated, to output to a receiver of the message a receiver specific negative indication, indicating non-validation.

### BRIEF DESCRIPTION OF THE DRAWINGS

In order to understand the presently disclosed subject matter and to see how it may be carried out in practice, embodiments will now be described, by way of non-limiting example only, with reference to the accompanying drawings, in which:

FIG. 1 is a high level block diagram of a network for messaging, according to some embodiments of the presently disclosed subject matter;

FIG. 2 is a block diagram of an indication basis establisher system, according to some embodiments of the presently disclosed subject matter;

FIG. 3 is a flowchart illustration of an indication basis establishing method, according to some embodiments of the presently disclosed subject matter;

FIG. 4 is a block diagram of a validator system, according to some embodiments of the presently disclosed subject matter;

FIG. 5 is a flowchart illustration of a validating method, according to some embodiments of the presently disclosed subject matter;

FIG. 6 is a block diagram of an indication provider system, according to some embodiments of the presently disclosed subject matter; and

FIG. 7 is a flowchart illustration of an indication providing method, according to some embodiments of the presently disclosed subject matter.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE DRAWINGS

Embodiments of the presently disclosed subject matter relate to networks, systems, methods, and/or computer program products for messaging. In some of these embodiments, a method may include: outputting a receiver specific indication of validation to a receiver of a message if a sender of the message has been validated. In these embodiments the outputted indication is specific to that receiver, although it is possible that the same indication may be specific to a plurality of receivers.

In the following detailed description, numerous specific details are set forth in order to provide a thorough understanding of the presently disclosed subject matter. However, it will be understood by those skilled in the art that some examples of the presently disclosed subject matter may be practiced without these specific details. In other instances, well-known methods, procedures and components have not been described in detail so as not to obscure the subject matter.

As used herein, the phrase “for example,” “such as”, “for instance”, “e.g.”, “optionally”, “possibly” and variants thereof describe non-limiting embodiments of the subject matter.

As used herein, and unless explicitly stated otherwise, the term “memory” refers to any module for storing data for the short and/or long term, locally and/or remotely. Examples of memory include inter-alia: any type of disk including floppy disk, hard disk, optical disk, CD-ROMs, magnetic-optical disk, magnetic tape, flash memory, random access memory (RAMS), dynamic random access memory (DRAM), static random access memory (SRAM), read-only memory (ROMs), programmable read only memory (PROM), electrically programmable read-only memory (EPROMs), electrically erasable and programmable read only memory (EEPROMs), magnetic card, optical card, any other type of media suitable for storing electronic instructions and capable of being coupled to a system bus, a combination of any of the above, etc.

Reference in the specification to “one embodiment”, “an embodiment”, “some embodiments”, “another embodiment”, “other embodiments”, “various embodiments”, “illustrated embodiments”, “one instance”, “some instances”, “one case”, “some cases”, “other cases” “various cases”, or variants thereof means that a particular feature, structure or characteristic described in connection with the embodiment(s) is included in at least one non-limiting embodiment of the presently disclosed subject matter. Thus the appearance of the phrase “one embodiment”, “an embodiment”, “some embodiments”, “another embodiment”, “other embodiments”, “various embodiments”, “illustrated embodiments”, one instance”, “some instances”, “one case”, “some cases”, “other cases”, various cases, or variants thereof does not necessarily refer to the same embodiment(s).

The term “illustrated embodiments”, is used to direct the attention of the reader to one or more of the figures, but should not be construed as necessarily favoring any embodiment over any other.

It should be appreciated that certain features, structures, and/or characteristics, which are, for clarity, described in the context of separate embodiments, may also be provided in combination in a single embodiment. Conversely, various features, structures and/or characteristics which are, for brevity, described in the context of a single embodiment, may also be provided separately or in any suitable sub-combination.

Unless specifically stated otherwise, as apparent from the following discussions, it is appreciated that throughout the specification discussions utilizing terms such as “accessing”, “receiving”, “establishing”, “configuring”, “determining”, “providing”, “performing”, “indicating”, “sending”, “including”, “incorporating”, “handling”, “adding”, “modifying”, “saving”, “outputting”, “manipulating”, “validating”, “authenticating”, “presenting”, “storing”, “enabling”, “causing”, “triggering” “obtaining”, “associating”, “executing”, “allowing”, “using”, “tailoring”, “selecting”, “inputting”, “attempting”, “creating”, “arranging”, “establishing”, “processing”, “communicating”, “generating”, “producing”, “deriving”, or the like, refer to the action and/or processes of any combination of software, hardware and/or firmware. For example, these terms may refer in some cases to the action and/or processes of a machine, that manipulates and/or transforms data into other data, the data represented as physical, such as electronic quantities, and/or the data representing physical objects.

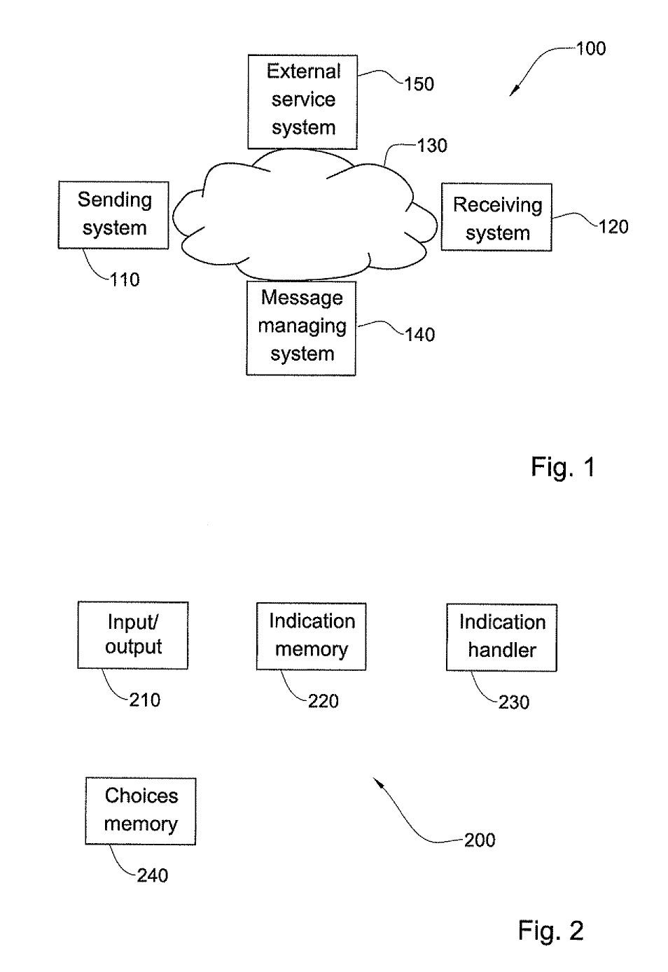

Referring now to the drawings, FIG. 1 schematically illustrates an example of a network 100 for messaging, according to some embodiments of the presently disclosed subject matter. In the illustrated embodiments, network 100 includes one or more sending systems 110 configured to send messages, one or more receiving systems 120 configured to receive messages, and one or more communication channels 130. Optionally, network 100 may also include one or more message managing systems 140 and/or one or more external service system(s) 150. Embodiments of the presently disclosed subject matter do not limit the type(s) of messages transferred via network 100. Examples of types of messages include: email messages (e.g. web-based email client based, etc.), SMS, social network messages (e.g. Facebook messages, Twitter “tweets”, etc.), instant messaging messages, a combination of the above, etc. Each sending system 110, receiving system 120, message managing system 140 and/or external service system 150 may be made up of any combination of hardware, software and/or firmware capable of performing the operations as defined and explained herein. For example, in some embodiments, any of sending system(s) 110, receiving system(s) 120 message managing system(s) 140 and/or external service system(s) 150 may comprise a machine specially constructed for the desired purposes, and/or may comprise a programmable machine selectively activated or reconfigured by specially constructed program code. Additionally or alternatively, in some embodiments, any of sending system(s) 110, receiving system(s) 120, message managing system(s) 140 and/or external sender validation service system(s) 150 may comprise at least some hardware. For simplicity of illustration and description, sending system 110, receiving system 120, communication channel 130, message managing system 140 and external service system 150 are generally referred to below in the single form, but usage of the single form for any particular element should be understood to include both embodiments where there is one of the particular element in network 100 and embodiments where there is a plurality of the particular element in network 100.

Features of sending system 110 may vary depending on the embodiment. For example, in various embodiments part or all of sending system 110 may be included in user device(s) such as personal computer(s), cell phone(s), smartphone(s), laptop(s), tablet computer(s), etc., may be included in element(s) which service multiple user devices such as proxy server(s), gateway(s), other type(s) of server(s), etc, and/or may be included in any combination of the above.

Features of message managing system 140 (if included) may vary depending on the embodiment. In some embodiments, part or all of message managing system 140 may be included in gateway(s), proxy server(s), other type(s) of server(s), and/or any other element(s) servicing multiple user devices, etc. In some embodiments, message managing system 140 may include any system which provides web-based message management for a plurality of users (where the plurality of users includes the receiver discussed herein), for instance a webmail provider system such as Yahoo®, Gmail™, etc.

Features of external service system 150 (if included) may vary depending on the embodiment. In some embodiments, part or all of external service system 150 may be included in gateway(s), proxy server(s), other type(s) of server(s), and/or any other element(s) servicing multiple user devices, etc.

Features of receiving system 120 may vary depending on the embodiment. For example, in various embodiments part or all of receiving system 120 may be included in user device(s) such as personal computer(s), cell phone(s), smartphone(s), laptop(s), tablet computer(s), etc., may be included in element(s) which service multiple user devices such as proxy server(s), gateway(s), other type(s) of server(s), etc, and/or may be included in any combination of the above. For simplicity's sake, any user device associated with a receiver is characterized herein below as being associated with receiving system 120 even if the user device is not necessarily used for receiving messages.

In some embodiments, a particular location or locations may include a sending system such as system 110 and a receiving system such as system 120 which may or may not be integrated with one another. In these embodiments, the functionality of the particular location(s) with respect to sending and/or receiving may in some cases vary for different messages. In some embodiments, additionally or alternatively, a specific location or locations may include only a sending system such as system 110 or only a receiving system such as system 120. In these embodiments, the message sending or receiving functionality of the specific location(s) may in some cases be consistent for all messages.

Features of communication channel 130 may vary depending on the embodiment. For example, in various embodiments, there may be one or more communication channel(s) 130 between any pair of systems in network 100, and any communication channel 130 between any pair of systems in network 100 may comprise any suitable infrastructure for network 100 that provides direct or indirect connectivity between those two systems. It is noted that a communication channel between one pair of systems in network 100 may or may not be the same as a communication channel between another pair of systems in network 100. Communication channel 130 may use for example one or more wired and/or wireless technology/ies. Examples of channel 130 may include cellular network channel, personal area network channel, local area network channel, wide area network channel, internetwork channel, Internet channel, any combination of the above, etc.

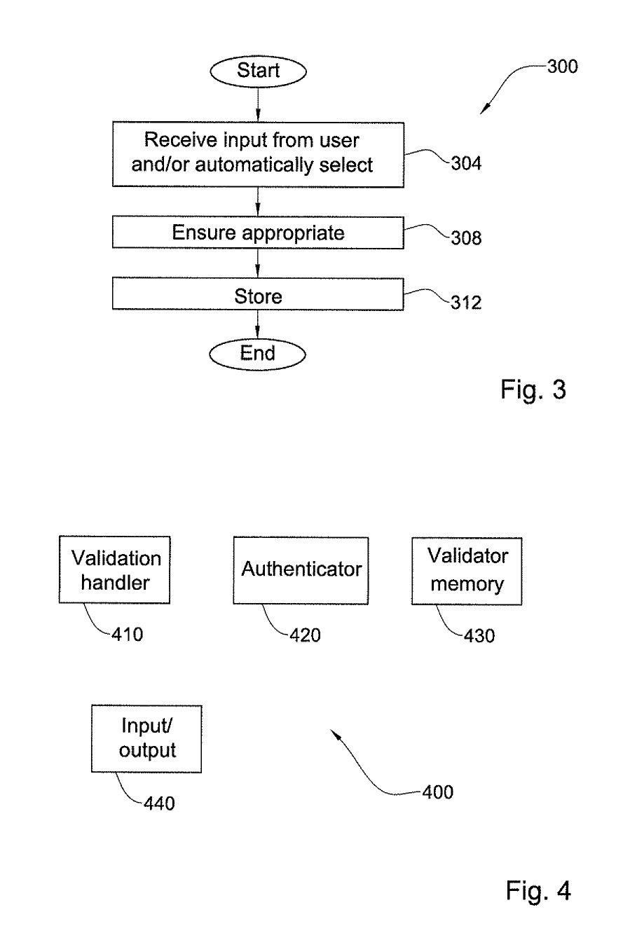

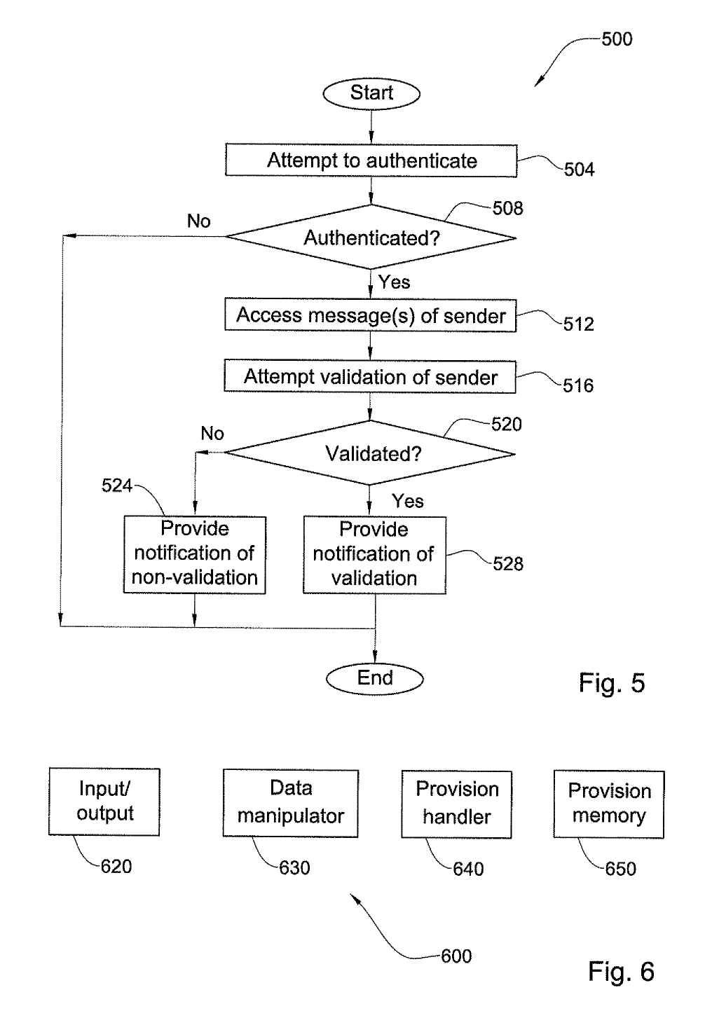

Some embodiments of methods and systems for indicating a valid sender will now be described with reference to FIGS. 2 to 6. In various embodiments, a system for indicating a valid sender may include one, a subset of, or all of the modules described with reference to any of FIGS. 2, 4 and/or 6. In various embodiments, a method for indicating a valid sender may include one, a subset of, or all of the stages described with reference to any of FIGS. 3, 5, and/or 7.

FIG. 2 is a block diagram of an indication basis establisher system 200, according to some embodiments of the presently disclosed subject matter. In the illustrated embodiments, indication basis establisher system 200 includes any of the following: one or more user input/output module(s) 210 configured to receive input from a user and/or output data to a user, one or more indication memory module(s) 220 configured to store data relating to indication basis (and optionally “negative” indication basis), one or more indication handler module(s) 230 configured to handle establishing of indication basis (and optionally “negative” indication basis), and/or one or more choices memory module(s) 240 configured to store choices which may be selected by a user or may be automatically selected. When included, each of user input/output 210, indication memory 220, indication handler 230 and/or choices memory 240 may be made up of any combination of hardware, software and/or firmware capable of performing the operations as defined and explained herein. Examples of user input/output 210 may include keyboard, mouse, camera, keypad, touch-screen display, microphone, speaker, non-touch-screen display, and/or printer, etc.

Depending on the embodiment, modules in indication basis establisher system 200 may be concentrated in the same location, for instance in one unit or in various units in proximity of one another, or modules of indication basis establisher system 200 may be dispersed over various locations.

In some cases, modules in indication basis establisher system 200 may be included in (or in other words located at) receiving system 120, message managing system 140, external service system 150 and/or elsewhere in network 100. Additionally or alternatively, in some cases any of the modules of indication basis establisher system 200 may be included in any of the following which may be comprised in receiving system 120, message managing system 140, external service system 150 and/or elsewhere in network 100: a web browser; a mail client; an instant messaging client; any other type of Internet client; a peer-to-peer application; a user interface; an SMS application; an MMS application; a messaging application; a plug-in, an add-on, a toolbar or an applet for a browser, email client, instant messaging client or any other application; a standalone client; any other suitable element servicing one user device; a gateway; a proxy server; any other type of server; a Web service, any other suitable element servicing multiple user devices; and/or an element with any other suitable configuration, etc.

In some cases, indication basis establisher system 200 may comprise fewer, more, and/or different modules than those shown in FIG. 2. For instance, memory modules 220 and 240 may in some of these cases be represented collectively as memory. Additionally or alternatively, in another instance of these cases indication basis establisher system 200 may include one or more indication handler module(s) 230 and any system (e.g. receiving system 120, message managing system 140, and/or external service system 150) which includes at least one indication handler module 230 may be considered an indication basis establisher system. Additionally or alternatively, in some cases, the functionality of indication basis establisher system 200 described herein may be divided differently among the modules of FIG. 2. Additionally or alternatively, in some cases, the functionality of indication basis establisher system 200 described herein may be divided into fewer, more and/or different modules than shown in FIG. 2 and/or indication basis establisher system 200 may include additional, less and/or different functionality than described herein.

FIG. 3 is a flowchart illustration of an indication basis establishing method 300, according to some embodiments of the presently disclosed subject matter. Method 300 may be performed in some cases by indication basis establisher system 200. In some cases, method 300 may include fewer, more and/or different stages than illustrated in FIG. 3, the stages may be executed in a different order than shown in FIG. 3, stages that are illustrated as being executed sequentially may be executed in parallel, and/or stages that are illustrated as being executed in parallel may be executed sequentially.

It is noted that the term “basis” is used with respect to indication basis establisher system 200 and indication basis establishing method 300 because depending on the embodiment, the indication basis which is established via method 300 may or may not be identical to the indication which would be provided to the receiver upon sender validation. For instance, the established indication basis may be different than the provided indication in cases where the indication is derived at least partly by tailoring the basis to a situation (e.g. to the sender, sender group, geographic location of sender, geographic location of receiver, message characteristic(s), receiving user device, and/or receiving application, etc.) and/or in cases where the provided indication also includes generic elements.

In the illustrated embodiments, in stage 304, input regarding a receiver specific indication of sender validation is received by one or more indication handler module(s) 230 and/or data regarding the receiver specific indication of sender validation is automatically selected.

For instance, assuming embodiments where input is received, the potential and/or actual receiver of message(s) may provide input via one or more user input/output module(s) 210 on a user device associated with the receiver and this input may be provided to indication handler 230. The user device used by the potential and/or actual receiver for inputting is characterized for simplicity's sake as associated with (potential or actual) receiving system 120, but depending on the embodiment this user device may or may not be the same user device which may later output a receiver specific indication when a sender has been validated.

If the input is provided prior to a message being received (e.g. prior to being received by (potential) receiving system 120 and/or message managing system 140), the receiver who provides the input may be considered a “potential” receiver. If the input is provided after the message has been received (e.g. by receiving system 120 and/or message managing system 140), the receiver who provides the input may be considered an “actual” receiver. Depending on the embodiment, input may be provided when the receiver is still a potential receiver, when the receiver is an actual receiver, or partly when the receiver is a potential receiver and partly when the receiver is an actual receiver. Therefore the term receiver as used in the description of method 300 (and elsewhere herein) should be construed as actual and/or potential receiver, as appropriate.

Depending on the embodiment with receiver input, the data inputted by the receiver and/or data selected from available choices by input of the receiver may be included in the receiver specific indication basis. Therefore depending on the embodiment with receiver input, the inputting may or may not include selecting.

In some of these embodiments with receiver input, the receiver may type in a phrase, and/or say a phrase to be included in the receiver specific indication basis. Additionally or alternatively, in some of these embodiments, the receiver may select input image(s) and/or graphical user interface GUI element(s) from among one or more offered choice(s) to be included in the receiver specific indication basis. Optionally, in some cases, one or more of the offered choice(s) may include data associated with the receiver on a sender website, and the receiver may select this data. In some instances of these cases the offered choices may include a plurality of data associated with the receiver on a sender website and the receiver may select from among this plurality of data. The sender may or may not know in these instances which data is actually selected.

In some of these embodiments, in addition to or instead of user input regarding receiver specific indication, data to be included in a receiver specific indication basis may be automatically selected in stage 304. For instance, one or more indication handler module(s) 230 may randomly select data to be included in a receiver specific indication basis from among available choices (e.g. stored in one or more choices memory module(s) 240). Additionally or alternatively for instance, one or more indication handler module(s) 230 may select default data to be included in a receiver specific indication basis. Additionally or alternatively for instance, one or more indication handler module(s) 230 may analyze the website of a sender to detect data (e.g. image and/or GUI element, etc.) which is associated with the receiver (e.g. displayed as part of the process of the receiver logging on to the web site of the sender, etc.). In this instance, indication handler module(s) 230 may select this associated data (e.g. image and/or GUI element, etc.) to be included in a receiver specific indication basis. The receiver specific indication basis in this instance may or may not correspond exclusively to that sender or to a sender group including that sender. Possibly, in some cases of this instance rather than selecting the associated data, data may be selected from among a plurality of data associated with the receiver on the web site of the sender. In these cases, the sender may or may not know which data is actually selected.

In some of these embodiments, indication handler module(s) 230 for performing stage 304 may be included in (potential or actual) receiving system 120, in one or more external service system(s) 150, in message managing system and/or elsewhere in network 100.

Depending on the embodiment, the receiver specific indication basis may include auditory data, visual data (e.g. alphanumeric, image, GUI element, color, size, and/or font, etc), and/or any other type of data.

Depending on the embodiment, there may be only one receiver specific indication basis or a plurality of receiver specific indication bases for a particular receiver. In some embodiments with a plurality of receiver specific indication bases for a particular receiver, a certain indication basis specific to that receiver may also be specific to certain situation (s). The subject matter does not limit the situation (s) for which a basis (or an indication) may be specific and depending on the embodiment, any situation may be considered appropriate. However, for further illustration to the reader, some examples of specific to situation (s) are provided herein below such as specific to a certain sender, sender group, message characteristic(s), geographic location of sender, geographic location of receiver, receiving user device and/or receiving application, etc. (Although specific, it is possible that the same indication basis may be specific to a plurality of situations such as specific to a plurality of senders, sender groups, message characteristics, geographic locations of sender, geographic locations of receiver, receiving user devices and/or receiving applications, etc). Therefore in some cases of these embodiments there may be different receiver specific indication bases corresponding to different senders, different receiver specific indication bases corresponding to different sender groups, different receiver specific indications corresponding to different geographic locations, different receiver specific indication bases corresponding to different message characteristics, different receiver specific indication bases corresponding to different receiving user devices, and/or different receiver specific indication bases corresponding to different receiving applications, etc.

In some embodiments of stage 304, receiving system 120 and/or message managing system 140 may communicate with one or more external service system(s) 150 during stage 304. For instance indication handler module(s) 230 in receiving system 120 and/or message managing system 140 may communicate with one or more indication handler module(s) 230 in external service system(s) 150. In some cases of these embodiments, the receiver may select from among choices stored at one or more external service system(s) 150 (e.g. stored in one or more choices memory module(s) 240, assuming data stored in choices memory module(s) 240 is accessible to external service system(s) 150).

Regardless of whether or not input is received from the receiver regarding a receiver specific indication, the receiver may optionally configure other constraint(s) such as validation parameter(s), data manipulation stipulation(s) and/or condition(s) for providing the receiver specific indication to the receiver. For instance, in some cases, as part of validation parameter(s), the receiver may configure when validation should or should not take place and/or which validation technique(s) should be used (e.g. depending on situation such as depending on sender, sender group, geographic location of sender, geographic location of receiver, receiving user device, receiving application, and/or message characteristic(s), etc), etc. In some other cases, for instance, the receiver may not necessarily configure all validation parameters. In these latter cases, default validation parameter(s) and/or randomly selected validation parameter(s) may be automatically selected in addition to or instead of configured condition(s).

In some cases, for instance, the receiver may configure data manipulation stipulation(s) such as when data manipulation is desirable and the desired manipulation(s) (e.g. depending on situation such as depending on sender, sender group, geographic location of sender, geographic location of receiver, receiving user device, receiving application, and/or message characteristic(s), etc). In some other cases, for instance the receiver may not necessarily configure all data manipulation stipulation(s). In these latter cases, default data manipulation stipulation(s) and/or randomly selected data manipulation stipulation(s), may be automatically selected in addition to or instead of configured stipulation(s).

In some cases for instance, the receiver may configure condition(s) for providing a receiver specific indication and/or additional data to the receiver such as when, where and/or how a receiver specific indication and/or additional data would be provided. For example, in some of these cases the receiver may configure condition(s) such as any mouse-over functionality, any click to listen/see functionality, any type of automatic tailoring (e.g. specific to a situation such as specific to a sender, specific to a sender group, specific to a receiving user device, specific to geographic location of sender, specific to geographic location of receiver, specific to receiving application, and/or specific to message characteristic(s), etc), and/or placement of indication (e.g. inside message area, outside message area, adjacent to message area, and/or in message list area, etc), etc. In some other cases, for instance, the receiver may not necessarily configure all provision conditions. In these latter cases, default provision condition(s) and/or randomly selected provision condition(s) may be automatically selected in addition to or instead of configured condition(s).

In the illustrated embodiments, in optional stage 308, receiver specific indication basis/(es), validation parameter(s), data manipulation stipulation(s) and/or provision condition(s) is/are processed to ensure suitability. For instance, one or more indication handler module(s) 230 may process the receiver specific indication basis/es, validation parameter(s), data manipulation stipulation(s), and/or provision condition(s). In some cases of this instance, indication handler module(s) 230 for processing may be included in receiving system 120, in one or more external service system(s) 150, in message managing system 140 and/or elsewhere in network 100.

In some of these embodiments, the processing may include filtering receiver specific indication basis/es for obviousness, checking if receiver specific indication basis/es meet(s) certain criteria (e.g. minimum length, etc), etc.

In some embodiments, stage 308 may be omitted. For instance in some cases of these embodiments if any receiver specific indication basis/es, validation parameter(s), data manipulation stipulation(s), and/or provision condition(s) would be appropriate then stage 308 may be omitted. Additionally or alternatively, for instance, stage 308 may be omitted if the procedure for providing receiver specific indication basis/es, validation parameter(s), data manipulation stipulation(s), and/or provision condition(s) (e.g. in some cases of these embodiments—automatic default selection) guarantees suitability.

In the illustrated embodiments, in optional stage 312, the receiver specific indication basis/es is/are stored in one or more indication memory module(s) 220 by one or more indication handler module(s) 230. In these embodiments, indication memory module(s) 220 may be shared with or accessible to a validator system such as a validator system 400 which is configured to perform validation and/or may be shared with or accessible to an indication provider system, such as an indication provider system 600, which is configured to provide a receiver specific indication upon validation.

In some of these embodiments, stage 312 storage of receiver specific indication basis/es may be omitted because storing of the receiver specific indication basis/es may not be necessary. For instance, if user input is received and/or automatic selection (e.g. default, random, and/or from a sender website, etc.) of a receiver specific indication or basis is performed each time a sender is validated and/or an indication is to be provided to a receiver, then storing of receiver specific indication base/es may not necessarily occur.

Regardless of whether or not indication basis/es are stored in stage 312, validation parameter(s), data manipulation stipulation(s) and/or provision condition(s) may or may not be stored. For instance, in some cases validation parameter(s) may additionally or alternatively be stored in one or more indication memory module(s) 220 by one or more indication handler module(s) 230. In these cases, indication memory module(s) 220 may be shared with or accessible to a validator system, such as validator system 400, which is configured to perform validation. In other cases of this instance, validation parameter(s) may not necessarily be stored. In another instance, in some cases data manipulation stipulation(s) may additionally or alternatively be stored in one or more indication memory module(s) 220 by one or more indication handler module(s) 230. In these cases, indication memory module(s) 220 may be shared with or accessible to a validator system, such as validator system 400, which is configured to perform validation and/or may be shared with or accessible to an indication provider system, such as indication provider system 600, which is configured to provide the indication upon validation. In other cases of this instance, data manipulation stipulation(s) may not necessarily be stored. In another instance, in some cases, provision condition(s) may additionally or alternatively be stored in one or more indication memory module(s) 220 by one or more indication handler module(s) 230. In these cases, indication memory module(s) 220 may be shared with or accessible to a validator system, such as validator system 400, which is configured to perform validation and/or may be shared with or accessible to an indication provider system, such as indication provider system 600, which is configured to provide the indication upon validation. In other cases of this instance, provision condition(s) may not necessarily be stored.

In various embodiments with storing stage 312, indication memory module(s) 220 may be included in one or more external service system(s) 150, in receiving system 120, message managing system 140, and/or elsewhere in network 100. Additionally or alternatively, for instance, indication handler module(s) 230 for storing may be included in various of these embodiments in receiving system 120, in one or more external service system(s) 150, in message managing system 140, and/or elsewhere in network 100.

In some embodiments where method 300 involves a plurality of external service systems 150, the reason for the plurality of external service systems may vary depending on the embodiment. For instance, different external service systems 150 may perform different processing, and/or external service system(s) 150 involved in the (automatic and/or user inputted) choice selection may be different than external service system(s) 150 involved in the processing, etc.

In some embodiments of method 300, the establishing of receiver specific indication basis/es may include stage 304 and optionally stage 308 and/or 312. In some of these embodiments the establishing may be performed by indication handler 230 and optionally by other module(s) in indication basis establisher system 200.

Depending on the embodiment, there may or may not be “negative” indication(s) (the term “negative” is used herein for an indication which indicates non-validation of a sender). In embodiments with negative indications, the negative indication(s) may or may not be specific to a receiver. Depending on the embodiment, basis/es for negative indication(s) may or may not be established as described above with reference to any of stages 304 to 312. For example, in some cases of embodiments where there are receiver specific negative indication(s), input regarding receiver specific negative indication(s) may be received from the receiver and/or data to be included in receiver specific negative indication basis/es may be automatically selected. In embodiments with validation parameter(s), data manipulation stipulation(s), and/or provision condition(s) associated with the negative indication(s) (receiver specific or not receiver specific), the validation parameter(s), data manipulation stipulation(s) and/or provision conditions(s) may be configured by the receiver and/or automatically selected, depending on the embodiment. Depending on the embodiment, the negative indication basis/es (receiver specific or not receiver specific), validation parameter(s), data manipulation stipulation(s) and/or provision condition(s) may or may not be processed, and/or the negative indication basis/es, validation parameter(s), data manipulation stipulation(s) and/or provision condition(s), may or may not be stored.

FIG. 4 is a block diagram of validator system 400, according to some embodiments of the presently disclosed subject matter. In the illustrated embodiments, validator system 400 includes any of the following: one or more validation handler module(s) 410 configured to handle validation, one or more authenticator module(s) 420 configured to authenticate, one or more validator memory module(s) 430 configured to store data relating to validation, and/or one or more user input/output 440 configured to receive input from a user and/or output data to a user. When included, each of validation handler 410, authenticator 420 validator memory 430, and/or user input/output 440 may be made up of any combination of hardware, software and/or firmware capable of performing the operations as defined and explained herein. Examples of user input/output 440 may include keyboard, mouse, camera, keypad, touch-screen display, microphone, speaker, non-touch-screen display, and/or printer, etc.

Depending on the embodiment, modules in validator system 400 may be concentrated in the same location, for instance in one unit or in various units in proximity of one another, or modules of validator system 400 may be dispersed over various locations.

In some cases, modules in validator system 400 may be included in (or in other words located at) receiving system 120, message managing system 140, external service system 150, and/or elsewhere in network 100. Additionally or alternatively, in some cases any of the modules of validator system 400 may be included in any of the following which may be comprised in receiving system 120, message managing system 140, external service system 150 and/or elsewhere in network 100: a web browser; a mail client; an instant messaging client; any other type of Internet client; a peer-to-peer application; a user interface; an SMS application; an MMS application; a messaging application; a plug-in, an add-on, a toolbar or an applet for a browser, email client, instant messaging client or any other application; a standalone client; any other suitable element servicing one user device; a gateway; a proxy server; any other type of server; a Web service, any other suitable element servicing multiple user devices; and/or an element with any other suitable configuration; etc.

In some cases, validator system 400 may comprise fewer, more, and/or different modules than those shown in FIG. 4. For instance, validator system 400 may in some of these cases include one or more validation handler module(s) 410 and any system (e.g. receiving system 120, message managing system 140, and/or external service system 150) which includes at least one validation handler module 410 may be considered a validator system. Additionally or alternatively, in some cases, the functionality of validator system 400 described herein may be divided differently among the modules of FIG. 4. Additionally or alternatively, in some cases, the functionality of validator system 400 described herein may be divided into fewer, more and/or different modules than shown in FIG. 4 and/or validator system 400 may include additional, less and/or different functionality than described herein.

FIG. 5 is a flowchart illustration of a validating method 500, according to some embodiments of the presently disclosed subject matter. Method 500 may be performed in some cases by validator system 400. In some cases, method 500 may include fewer, more and/or different stages than illustrated in FIG. 5, the stages may be executed in a different order than shown in FIG. 5, stages that are illustrated as being executed sequentially may be executed in parallel, and/or stages that are illustrated as being executed in parallel may be executed sequentially.

In the illustrated embodiments, in optional stage 504, validator system 400, for instance authenticator 420, attempts to authenticate the receiver. For instance, the receiving user may be required to log in (e.g. with user name and/or password, etc.) during the authentication attempt, using input/output 440. In some cases of these embodiments, the receiver may be required to be authenticated before validation is attempted for any messages destined for the receiver for which validation has not previously been attempted or for which validation has not previously succeeded.

In some of these embodiments, validator system 400 may be included in a plurality of external service systems 150. In these embodiments, the authentication attempt stage 504 may or may not involve one or more external service system(s).

In the illustrated embodiments, in optional stage 508, it is determined if the receiver has been authenticated. If authenticated (yes to stage 508), then in the illustrated embodiments method 500 continues with stage 512. If not authenticated (no to stage 508), then in the illustrated embodiments method 500 ends.

In some of these embodiments, stages 504 and 508 may be omitted, for instance if validation is performed for all receivers without requiring prior authentication. In these embodiments, method 500 may begin with stage 512. In some of these embodiments, stages 504 and 508 may be postponed until after validation has been attempted, with notification of validation (or optionally of non-validation) only provided after the user has been authenticated.

In some of these embodiments, validation parameter(s) may have been previously determined and/or may be currently determined. The validation parameter(s) may be the same for any message or may vary (e.g. based on situation, such as based on sender, sender group, message characteristic(s), geographic location of sender, geographic location of receiver, receiving user device, and/or receiving application, etc.). For instance, validation parameter(s) (which may have been previously configured by the receiver, previously randomly automatically selected, and/or previously automatically selected as a default) may have been previously stored (e.g. in indication memory 220). Additionally or alternatively for instance, validation parameter(s) may be configured by the receiver, randomly automatically selected and/or automatically selected as a default while validating method 500 is being performed. In embodiments with validation parameter(s), validator system 400, for instance validation handler 410, may check if the validation parameter(s) coincide with proceeding with validation. In these embodiments, it is assumed that validation parameter(s) has/have been met for any messages that will be accessed in stage 512. In other of these embodiments, proceeding with validation for any message is the default and therefore determination of validation parameter(s) and/or checking of any determined validation parameter(s) may not be required prior to proceeding with stage 512. In other of these embodiments, not proceeding with validation is the default, meaning that method 500 may end at this point.

In the illustrated embodiments, in stage 512 validator system 400, for instance validation handler 410 accesses the message(s) whose sender(s) is/are to be attempted to be validated.

In some of these embodiments, the message(s) which is/are accessed may have been previously received by receiving system 120 and/or by message managing system 140. In these embodiments, the message(s) may be accessible to validator system 400, for instance because at least part of validator system 400 is included in receiving system 120 and/or in message managing system 140. Additionally or alternatively, in some of these embodiments where at least part of validator system 400 is included in one or more external service system(s) 150, validator system 400 may have access to the message(s), for instance, because external service system(s) 150 may have previously received the message(s). In these embodiments, external service system(s) 150 may have previously received the message(s), for instance, by intercepting the message(s) before the message(s) reached receiving system 120 and/or message managing system 140, or for instance, because receiving system 120 and/or message managing system 140 may have provided the message(s) to external service system(s) 150.

The trigger for accessing a message in stage 512 may vary depending on the embodiment. For instance, in some of these embodiments the receipt of a message (e.g. by receiving system 120, message managing system 140 and/or external service system(s) 150 which include(s) at least part of validator system 400) may trigger stage 512. Additionally or alternatively, for instance, in some of these embodiments authentication of the receiver may trigger stage 512 for any messages for which validation has not previously been attempted or for which validation has not previously succeeded. In embodiments where the sender(s) of more than one message are to be validated, an iteration of stages 512 to 528 may be performed for each message separately, or each of these stages may be performed for a subset of the messages (for instance messages from the same sender or sender group) or for all of the messages before proceeding to the next stage.

In the illustrated embodiments, in stage 516 validation of the sender(s) is attempted for the message(s), for instance by validation handler 410.

Depending on the embodiment, the validation attempt may include any appropriate validation technique(s). In some embodiments of stage 516 where there may be validation parameter(s), validation technique(s) may be applied in accordance with the validation parameter(s). In some embodiments of stage 516 (where there may or may not be validation parameter(s)), there may be default validation technique(s) which are applied.

The subject matter does not limit validation techniques and any validation techniques may be considered suitable depending on the embodiment. However for further illustration to the reader, some examples of validation technique(s) are now described.

In some embodiments of stage 516, the validation attempt may include checking the digital signature of the message. The checking of the digital signature may use, for example, one or more standards such as DKIM, Domainskeys, S/MIME, POP, etc.

Additionally or alternatively, in some embodiments of stage 516 the validation attempt may be performed using a section in the message body which was digitally signed.

Additionally or alternatively, in some embodiments of stage 516 the validation attempt may include checking that the message origin IP address is listed as a valid IP address from which messages can be sent on behalf of the sender. For example the checking may use a standard such as SPF.

Additionally or alternatively, in some embodiments of stage 516, the validation attempt may be performed from a pre-defined list. In some examples of these embodiments, if a sender belongs to a list of senders for which validation is appropriate (e.g. a hardcoded white list, and/or a white list stored in validator memory 430, etc), the sender is validated. In these examples, if a sender instead belongs to a list of senders for which invalidation is appropriate (e.g. a hardcoded black list, and/or a black list stored in validator memory 430, etc.), the sender is invalidated.

Additionally or alternatively, in some embodiments of stage 516, the validation attempt may include one or more technique(s) described in co-pending U.S. application Ser. No. 13/193,120 “Enabling active content in messaging using automatic data replacement”, filed on Jul. 28, 2011 which is hereby incorporated by reference herein. By way of example, the reader is referred to the description of stages 312 and/or 328 in method 300 of that application.

Additionally or alternatively, in some embodiments of stage 516, the validation attempt may involve one system or a plurality of systems. For example, the validation attempt may involve one system such as external service system 150, receiving system 120 or message managing system 140. In another example, the validation attempt may involve a plurality of systems for instance a plurality of external service systems 150; one or more external service system(s) 150 and receiving system 120; one or more external service system(s) 150 and message managing system 140; one or more external service system(s) 150, receiving system 120 and message managing system 140; message managing system 140 and receiving system 120; etc. In some embodiments where a plurality of systems are involved in validation, the different systems may perform the same validation techniques or different validation techniques.

In embodiments of stage 516 where the validation attempt may involve a plurality of systems, the reason for the plurality of systems may vary depending on the embodiment. For instance, in some of these embodiments, the identity of the system(s) which perform(s) the validation may depend on the situation such as depending on sender (e.g. different systems for different sender sets), sender group (e.g. different systems for different sender group sets), geographic location(s) (of sender and/or receiver), characteristic(s) of the message, receiving user device, and/or receiving application, etc.

In the illustrated embodiments, in stage 520, it is determined if the sender was validated.

If not validated (no to stage 520), then in the illustrated embodiments in optional stage 524, notification that the sender has not been validated (i.e. of non-validation of the sender) is provided, for instance by validation handler 410. Depending on the embodiment, non-validation may occur because there is an absence of validation of the sender, or due to an active invalidation of the sender.

Depending on the embodiment, a non-validation notification may be provided by pushing a notification to an indication provider system such as indication provider system 600, or a non-validation notification may be provided when requested by an indication provider system such as indication provider system 600. Depending on the embodiment, the notification may be provided as part of the message itself (e.g. in a header and/or elsewhere in the message) or may be provided separately from the message. For instance, in some embodiments, the notification may be included in a “message header field for indicating message authentication status” described in the proposed RFC 5451 (proposed April 2009), which is hereby incorporated by reference herein.

Depending on the embodiment, a notification of non-validation may include any appropriate data. For instance, depending on the embodiment the notification may or may not include a negative indication or negative indication basis (which may or may not be receiver specific). Additionally or alternatively, depending on the embodiment, the notification may or may not include data manipulation stipulation(s) and/or provision condition(s). In some embodiments where the notification does not include a negative indication or negative indication basis, data manipulation stipulation(s) and/or provision condition(s), the negative indication or basis, data manipulation stipulation(s) and/or provision condition(s) may not have been included if unknown to validator system 400 and/or if otherwise accessible to the indication provider system. In some of these embodiments, the notification may include certain data which indication provider system may be configured to process as signifying that the sender has not been validated, in addition to or instead of including a negative indication or basis.

In some embodiments, stage 524 may be omitted, and if there is no validation, then no notification may be provided.

If the sender has been validated (yes to stage 520), then in the illustrated embodiments in stage 528 notification of the validation is provided by validator system 400, for instance by validation handler 410.

Depending on the embodiment, validation notification may be provided by pushing a notification to an indication provider system such as indication provider system 600, or a validation notification may be provided when requested by an indication provider system such as indication provider system 600. Depending on the embodiment, the notification may be provided as part of the message itself (e.g. in a header and/or elsewhere in the message) or may be provided separately from the message. For instance, in some embodiments, the notification may be included in a “message header field for indicating message authentication status” described in the aforementioned proposed RFC 5451 (proposed April 2009).

Depending on the embodiment, a notification of validation may include any appropriate data. For instance, depending on the embodiment the notification may or may not include a receiver specific indication or receiver specific indication basis. Additionally or alternatively, depending on the embodiment, the notification may or may not include data manipulation stipulation(s) and/or provision condition(s). In some embodiments where the notification does not include an indication or basis, data manipulation stipulation(s) and/or any provision condition(s), the indication or basis, data manipulation stipulation(s), and/or provision condition(s) may not have been included if unknown to validator system 400 and/or if otherwise accessible to the indication provider system. In some of these embodiments, the notification may include certain data which indication provider system is configured to process as signifying that the sender has been validated, in addition to or instead of including the indication or basis.

Assuming embodiments where a notification (of validation or non-validation) includes data manipulation stipulation(s), and/or provision condition(s). In these embodiments, the data manipulation stipulation(s) and/or provision condition(s) may have been configured and/or automatically selected (e.g. randomly and/or as a default, etc.) while method 500 was being executed and/or before. Depending on the embodiment, the data manipulation stipulation(s) and/or provision condition(s) may be the same for any message or may vary (e.g. based on situation, such as based on sender, sender group, message characteristic(s), geographic location of sender, geographic location of receiver, receiving user device, and/or receiving application, etc.).

Assuming embodiments where a receiver specific indication basis or negative indication basis (which may or may not be receiver specific) was established which is different than the indication or negative indication which will be provided to the receiver. In some of these embodiments, validator system 400 may convert the indication basis or negative indication basis into the indication or negative indication, respectively, and include the indication or negative indication in the notification of validation or non-validation respectively. In these embodiments, for instance, the conversion may possibly include tailoring the basis in order to derive the indication or negative indication, so that the indication or negative indication is tailored to the situation such as tailored to sender, sender group, geographic location of sender, geographic location of receiver, message characteristic(s), receiving user device, and/or receiving application, etc. Additionally or alternatively in these embodiments, for instance, the conversion may possibly include adding generic element(s) (e.g. a generic element which would cause the visual display or audio reciting of the phrase “the sender of this message has been validated” or “the sender of this message has not been validated”, and/or a generic GUI element suggesting validation or non-validation, etc.). Continuing with this instance, generic element(s) are element(s) which would be added regardless of who is the receiver, and therefore an indication or negative indication which is receiver specific may still possibly also include one or more generic element(s). Prior to the conversion, the type of conversion (e.g. tailoring and/or adding generic elements, etc.) may have been configured and/or automatically selected (e.g. randomly and/or as a default, etc.) as part of the configuring and/or automatic selection of provision condition(s) in these embodiments. In some other of these embodiments where a receiver specific indication basis or negative indication basis (which may or may not be receiver specific) was established which is different than the indication or negative indication which will eventually be outputted, validator system 400 may not necessarily convert the indication or negative indication basis into the actual indication or negative indication. In these embodiments, validator system 400 may include the indication basis or negative indication basis in the notification.

Depending on the embodiment, the provision of notification of validation or non-validation may be performed by the same system or one of the systems in network 100 which attempted validation, or may be performed by a different system in network 100.

In the illustrated embodiments, method 500 ends.

FIG. 6 is a block diagram of indication provider system 600, according to some embodiments of the presently disclosed subject matter. In the illustrated embodiments, indication provider system 600 includes any of the following: one or more user input/output module(s) 620 configured to receive input from a user and/or output data to a user, one or more indication provision handler module(s) 640 configured to handle indication provision (and optionally negative indication provision), one or more data manipulator module(s) 630 configured to manipulate data, and/or one or more provision memory module(s) 650 configured to store data relating to indication provision (and optionally relating to negative indication provision). When included, each of input/output 620, indication provision handler 640, data manipulator 630 and/or provision memory 650 may be made up of any combination of hardware, software and/or firmware capable of performing the operations as defined and explained herein. Examples of user input/output 620 may include keyboard, mouse, camera, keypad, touch-screen display, microphone, speaker, non-touch-screen display, and/or printer, etc.

Depending on the embodiment, modules in indication provider system 600 may be concentrated in the same location, for instance in one unit or in various units in proximity of one another, or modules of indication provider system 600 may be dispersed over various locations.

In some cases, modules in indication provider system 600 may be included (or in other words located at) receiving system 120, message managing system 140, external service system 150, and/or elsewhere in network 100. Additionally or alternatively, in some case any of the modules of indication provider system 600 may be included in any of the following which may be comprised in receiving system 120, message managing system 140, external service system 150 and/or elsewhere in network 100: a web browser; a mail client; an instant messaging client; any other type of Internet client; a peer-to-peer application; a user interface; an SMS application; an MMS application; a messaging application; a plug-in, an add-on, a toolbar or an applet for a browser, email client, instant messaging client or any other application; a standalone client; any other suitable element servicing one user device; a gateway; a proxy server; any other type of server; a Web service, any other suitable element servicing multiple user devices; and/or an element with any other suitable configuration; etc.

In some cases, indication provider system 600 may comprise fewer, more, and/or different modules than those shown in FIG. 6. For instance, in some of these cases another instance of these cases indication provider system 600 may include one or more indication provision handler module(s) 640 and any system (e.g. receiving system 120, message managing system 140, and/or external service system 150) which includes at least one indication provision handler module 640 may be considered an indication provider system. Additionally or alternatively, in some cases, the functionality of indication provider system 600 described herein may be divided differently among the modules of FIG. 6. Additionally or alternatively, in some cases, the functionality of indication provider system 600 described herein may be divided into fewer, more and/or different modules than shown in FIG. 6 and/or indication provider system 600 may include additional, less and/or different functionality than described herein.

Although for simplicity of description, indication basis establisher system 200, validator system 400 and indication provider system 600 are described independently herein, depending on the embodiment, systems 200, 400 and/or 600 may or may not share modules. For example, although the described embodiments refer independently to input/output 210, 440 and 620, it is possible that in some embodiments reference to two or more of these modules is really referring to the same module or to interconnected modules. Additionally or alternatively, for example, although the described embodiments refer independently to memory 220, 240, 430, and 650 it is possible that in some embodiments reference to two or more of these modules is really referring to the same module or to interconnected modules. Additionally or alternatively, for example, although the described embodiments refer independently to handler 230, 410 and 640, it is possible that in some embodiments reference to two or more of these modules is really referring to the same module or to interconnected modules.

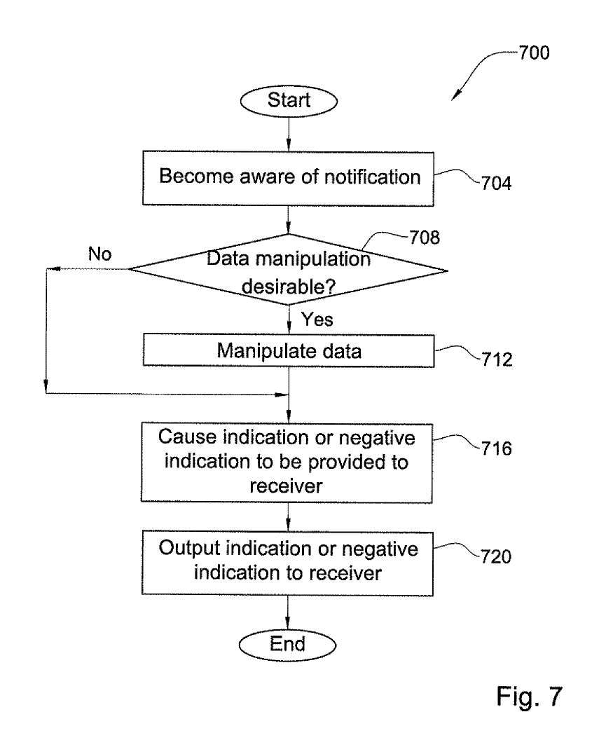

FIG. 7 is a flowchart illustration of an indication providing method 700, according to some embodiments of the presently disclosed subject matter. Method 700 may be performed in some cases by indication provider system 600. In some cases, method 700 may include fewer, more and/or different stages than illustrated in FIG. 7, the stages may be executed in a different order than shown in FIG. 7, stages that are illustrated as being executed sequentially may be executed in parallel, and/or stages that are illustrated as being executed in parallel may be executed sequentially.

In the illustrated embodiments, in stage 704, indication provider system 600, for instance indication provision handler 640 becomes aware of a notification regarding sender validation or non-validation. In embodiments where no notification is provided for non-validation, the notification for which indication provider system 600 becomes aware in stage 704 regards sender validation. For simplicity's sake, it is assumed in the remainder of the description of method 700 that a notification may be provided regarding sender validation or non-validation.

Depending on the embodiment, the notification may relate to one message or may relate to more than one message (e.g. from the same sender and/or sender group, etc).

The notification may include any appropriate data. For instance, depending on the embodiment the notification may or may not include a receiver specific indication or basis for validation, or may or may not include a negative indication (which may or may not be receiver specific) or basis for non-validation. Additionally or alternatively, depending on the embodiment, the notification may or may not include data manipulation stipulation(s) and/or provision condition(s). In some embodiments where the notification does not include an indication or basis, negative indication or basis, data manipulation stipulation(s) and/or provision condition(s), the indication or basis, negative indication or basis, data manipulation stipulation(s) and/or provision condition(s) may not have been included if unknown to validator system 400 and/or if otherwise accessible to indication provider system 600. In some of these embodiments, the notification may include certain data which indication provider system may be configured to process as signifying that the sender has been validated or not validated, in addition to or instead of including an indication, negative indication, indication basis, or negative indication basis.

In the illustrated embodiments, in optional stage 708, it is determined by indication provider system 600, for instance by data manipulator 630 whether or not data manipulation of the message is desirable.

In some of these embodiments where there is a possibility that data manipulation may be desirable, data manipulation stipulation(s) may or may not have been configured by the receiver or automatically selected prior to stage 708, including the desirability or non-desirability of manipulating data prior to providing the indication or negative indication to the receiver. In embodiments where there is a possibility that data manipulation may be desirable but the desirability of manipulating data prior to providing the indication or negative indication was not previously configured by the receiver or automatically determined, the desirability may be currently determined, for instance by automatic selection (e.g. randomly selected and/or based on a default, etc.) and/or by receiver configuration. Depending on the embodiment, the desirability of data manipulation may vary (e.g. based on situation such as based on sender, sender group, message characteristic(s), geographic location of sender, geographic location of receiver, receiving user device, and/or receiving application, etc.). In embodiments with default data manipulation, the default may be any default (e.g. always desirable or never desirable).

If data manipulation is desirable (yes to stage 708), then in the illustrated embodiments, message data is manipulated in optional stage 712, for instance by data manipulator 630.

Depending on the embodiment, data manipulation may include any appropriate data manipulation techniques. In some of these embodiments, previously configured and/or previously automatically selected data manipulation stipulation(s) may stipulate data manipulation techniques(s) to be performed. Additionally or alternatively, in some of these embodiments, the applied data manipulation techniques (s) may be currently configured and/or currently automatically selected (e.g. randomly and/or based on a default, etc).

For data manipulation stipulation(s) which were previously configured and/or previously automatically selected, the stipulation(s) may or may not have been included in the notification, depending on the embodiment. In some of these embodiments, stipulation(s) may be accessible to the data manipulator 630, for instance stored in memory 650.

The subject matter does not limit data manipulation techniques and any data manipulation techniques may be appropriate depending on the embodiment. However for further illustration to the reader, some examples of data manipulation techniques are now described.

For example, data manipulation may include decoding and/or decrypting.

Additionally or alternatively, for example, data manipulation may include manipulating message content to ensure that content is safe.

Additionally or alternatively, for example, data manipulation may include replacing at least some of the message content with content that is obtained from elsewhere (e.g. from external service system(s)).

Co-pending U.S. application Ser. No. 13/193,120 mentioned above describes inter-alia some of these data manipulation techniques. By way of example, methods 500 and 700 in that application (e.g. stages 504, 718, and/or 722) describe data manipulation.

If data manipulation is not desirable (no to stage 708), then in the illustrated embodiments stage 712 may be omitted.

In embodiments where data manipulation is never desirable prior to stage 716, then stages 708 and 712 may be omitted.

In the illustrated embodiments, in stage 716, indication provider system 600, for instance provision handler 640 causes the indication or negative indication to be provided to the receiver.

Depending on the embodiment, condition(s) for providing the indication or negative indication may have been previously configured by the receiver (prior to stage 716), previously automatically selected (prior to stage 716), currently configured by the receiver, and/or currently automatically selected (e.g. randomly selected and/or based on a default, etc). For previously configured and/or previously automatically selected condition(s), the condition(s) may or may not have been included in the notification, depending on the embodiment. In some of these embodiments, provision condition(s) may be accessible to the provision handler 640, for instance stored in memory 650. Depending on the embodiment, provision condition(s) may be the same for any message or may vary (e.g. based on situation such as based on sender, sender group, message characteristic(s), geographic location of sender, geographic location of receiver, receiving user device, and/or receiving application, etc.).

Depending on the embodiment, the indication or basis, or negative indication or basis, may have been included in the notification or may be accessible to provision handler 640, for instance stored in memory 650.

In some embodiments where the indication or basis, or negative indication or basis is accessible to provision handler 640, the indication or basis, or negative indication or basis may be accessible even if the receiver used a different associated user device when establishing the indication or negative indication basis than the user device which will output the indication or negative indication, and/or even if the indication or negative indication basis was automatically established.

As mentioned above an indication corresponding to validation is receiver specific (although it may optionally include one or more generic element(s)), whereas a negative indication corresponding to non-validation may or may not be receiver specific, depending on the embodiment. As mentioned above an indication or negative indication which is specific to one receiver, may not necessarily be uniquely specific, and therefore depending on the embodiment it may or may not be possible that the same indication or negative indication is specific to a plurality of receivers.

Depending on the embodiment, a receiver specific indication or negative indication (receiver specific or not) may or may not be known to the sender of the message. For instance, the indication or negative indication may not be known to the sender because the sender may not know what was input or automatically selected in stage 304 and/or because the sender may not know how the basis was converted (e.g. via tailoring and/or adding generic element(s)) by validator system 400 and/or indication provider system 600.

Depending on the embodiment, a receiver specific indication or negative indication may or may not be less likely to be known to a phisher or other fraudulent entity than a non receiver-specific indication or negative indication. In embodiments where a receiver specific indication is less likely to be known to a phisher (or other fraudulent entity) than a non receiver specific indication, the phisher (or other fraudulent entity) may be less likely to include the (correct) indication in a message, and therefore less likely to fool the receiver into thinking that the sender of the message has been validated.

Depending on the embodiment, a receiver specific indication or negative indication (receiver specific or not) which is to be provided to a particular receiver may or may not vary from previously provided indication(s)/negative indication(s) to that particular receiver. The variance, for instance, may be due to the indication or negative indication being specific to situation such as specific to sender, sender group, user device, receiving application, message characteristic(s), geographic location of sender, and/or geographic location of receiver, etc. (Note that even when specific to a situation, an indication or negative indication may not necessarily be uniquely specific to a situation such as uniquely specific to sender, sender group, user device, receiving application, message characteristic(s), geographic location of sender, and/or geographic location of receiver, etc).

For example in some of these embodiments, there may be different indications and/or negative indications corresponding to different senders, and/or different indications and/or negative indications corresponding to different sender groups. For instance, in some cases of these embodiments, a sender specific element such as a sender's logo, or a sender group specific element such a sender group's logo, may be included in a receiver specific indication corresponding to that sender or sender group respectively. In another instance, additionally or alternatively, an image or GUI element included in a receiver specific indication may vary depending on the sender or sender group. In another instance, additionally or alternatively some data (e.g. image and/or GUI element, etc.) included in a receiver specific indication may be the same as used by the website of the sender or sender group in association with the receiver.

Additionally or alternatively, in some of these embodiments, there may be different indications and/or negative indications depending on the user device which would be outputting the indication, and/or the receiving application. For instance, a certain type of user device may output a receiver specific indication which includes a sender or sender group specific logo, another may output a receiver specific indication (including receiver specific text and color) without any sender or sender specific element, a third may output a receiver specific indication (including only receiver specific color), etc. In another instance, additionally or alternatively the size of an image included in a receiver specific indication basis may vary depending on the parameters of the receiving user device (e.g. image size of 64×64 for personal computer, and 32×32 for mobile device such as cell phone, smartphone, laptop, or tablet computer).

Depending on the embodiment where the indication or negative indication that is to be provided to the receiver may vary (for instance, being specific to a situation such as being specific to sender, sender group, user device, receiving application, geographic location of sender, geographic location of receiver, and/or message characteristic(s) etc,) variance may be achieved by converting an indication basis or negative indication basis into various indications or negative indications (either by validator system 400 or indication provider system 600) and/or the variance may also be reflected in the various indication bases or negative indication bases (established by indication basis establisher system 200). In embodiments where any variance would also be reflected in the basis, the indication or negative indication to be provided to the receiver may possibly be identical to the corresponding basis. (Similarly in embodiments where there is no variance, the indication or negative indication to be provided to the receiver may possibly be identical to the corresponding basis). However, in embodiments where at least part of the variance may not be reflected in the basis, the indication or negative indication to be provided to the receiver may not necessarily be identical to the corresponding basis.

Assume embodiments where a basis is different than the indication or negative indication which is to be provided to the receiver and where indication provider system 600 (e.g. provision handler 640) converts an indication basis or negative indication basis into an appropriate indication or negative indication. In some of these embodiments, stage 716 may include converting the indication basis or negative indication basis into an indication or negative indication, respectively. For instance, the conversion may possibly include tailoring the basis in order to derive the indication or negative indication, so that the indication or negative indication is tailored to the situation such as tailored to sender, sender group, message characteristic(s), geographic location of sender, geographic location of receiver, receiving user device, and/or receiving application, etc.

As mentioned above, in some embodiments, part or all of the conversion may be unrelated to tailoring the indication basis or negative indication basis to the situation. For instance, in some embodiments, conversion may additionally or alternatively include adding generic element(s) (i.e. element(s) which would be added regardless of who is the receiver) to the indication basis or negative indication basis. Therefore an indication or negative indication which is receiver specific may still possibly also include one or more generic element(s).

In embodiments with conversion, prior to the conversion, the type of conversion (e.g. tailoring and/or adding generic elements, etc.) may have been configured, or automatically selected (e.g. randomly and/or as a default, etc.) as part of the provision condition(s).

Additionally or alternatively, in some embodiments of stage 716, provision handler 640 may act so as to cause the indication or negative indication to be correctly positioned (i.e. placed) when presented to the receiver. The subject matter does not limit correct placement and any placement may be considered correct, depending on the embodiment. For instance, provision handler 640 may act so as to cause the indication or negative indication to be presented in the area where the message is presented, presented adjacent to the area where the message is presented, presented outside the area where the message is presented, and/or presented in the area of a message list (which includes a listing of the message associated with the indication or negative indication). A message list may be any list of messages which may be presented to the receiver, and the subject matter does not limit the type. Examples of message lists include (summary) inbox message list, priority message list, message folder, deleted items folder, etc.

For instance, if the message is in HTML and the indication or negative indication is to be presented in the area where the message is presented, provision handler 640 may add HTML code so as to cause the indication or negative indication to be presented in the area where the message is presented. Additionally or alternatively, if the indication or negative indication is to be presented adjacent to the area where the message is to be presented, provision handler 640 may analyze the message display (e.g. interface) and place the indication or negative indication adjacent to the message display (e.g. right above the message body). Additionally or alternatively, for instance, if the indication or negative indication is to be presented outside the area where the message is presented, and/or in the message list area, provision handler 640 may change the presentation or use an application programming interface API to change the presentation from what the presentation would have looked like without the indication or negative indication. Continuing with this instance, in some cases, the indication or negative indication may be presented next to the sender “From” address, at the top of a web page, and/or anywhere else outside of the message display area and/or in the message list area.

Additionally or alternatively, in some embodiments of stage 716, provision handler 640 may act so as to cause at least part of the indication or negative indication to be provided to the receiver upon certain action(s) of the receiver. For instance, at least part of the indication or negative indication may be outputted to the receiver after the receiver places the mouse over a GUI element, and/or after the user clicks on a GUI element in order to see and/or listen to the at least part of the indication or negative indication. In this instance, depending on the example, the GUI element may or may not be part of the indication or negative indication. For example, the GUI element may in some cases be included in the “From” field and may not necessarily be part of the indication or negative indication. In some cases of this instance where at least part of the indication or negative indication is to be outputted after the receiver places the mouse over a GUI element provision handler 640 may use the alt attribute of the <img> HTML tag to cause at least part of the indication or negative indication to be outputted after the receiver places the mouse over a GUI element. In some cases of this instance where at least part of the indication or negative indication is to be outputted after the receiver clicks on a GUI element, provision handler 640 may additionally or alternatively use JavaScript with a pop up window to cause at least part of the indication or negative indication to be outputted after the receiver clicks on the GUI element.

In some embodiments of stage 716 where provision handler 640 acts to cause correct placement, prior to provision handler 640 acting to cause correct placement, the placement may have been configured by the receiver and/or automatically selected (e.g. randomly and/or as a default, etc.) as part of provision condition(s). Additionally or alternatively, in some of embodiments of stage 716 where provision handler 640 acts to cause at least part of the indication or negative indication to be provided to the receiver upon certain action(s) of the receiver, prior to provision handler 640 acting to cause at least part of the indication or negative indication to be provided to the receiver upon certain action(s) of the receiver, the action(s) by the receiver may have been previously configured by the receiver or automatically selected (e.g. randomly and/or as a default, etc.) as part of provision condition(s).

Depending on the embodiment, any of stages 704 to 716 may involve one system such as external service system 150, receiving system 120 or message managing system 140 or may involve a plurality of systems in network 100. For example, the plurality of systems may include a plurality of external service systems 150; one or more external service system(s) 150 and receiving system 120; one or more external service system(s) 150 and message managing system 140; one or more external service system(s) 150, receiving system 120 and message managing system 140; message managing system 140 and receiving system 120; etc.

In the illustrated embodiments, in stage 720 a receiver specific indication of sender validation or a negative indication of non-validation (receiver specific or not) is outputted to the receiver by indication provider system 600, for instance via output 620. Depending on the embodiment, the indication or negative indication may or may not be known to the sender. In one example of a method of providing an indication that a sender has been validated, the method example at least includes: outputting a receiver specific indication of validation to the receiver of the message in stage 720, if the sender of the message has been validated. In one example of a method of providing an indication that a sender has not been validated, the method example at least includes outputting a receiver specific negative indication, indicating non-validation, to the receiver of the message in stage 720, if the sender of the message has not been validated.

In some embodiments of stage 720, the indication or negative indication may be outputted in any position by indication provider system 600 (e.g. input/output 620), depending on what occurred in stage 716. For instance the indication or negative indication may be presented in an area where the message is being presented, adjacent to an area where the message is being presented, outside of an area where the message is being presented, in the area of the message list, etc.

In some embodiments of stage 720, at least part of the indication or negative indication may be outputted to the receiver after certain action(s) of the receiver, if this was caused by stage 716. For instance, indication provider system 600 (e.g. input/output 620) may output at least part of the indication or negative indication to the receiver after the receiver places the mouse over a GUI element and/or after the user clicks on a GUI element in order to see and/or listen to additional data.

In the illustrated embodiments, method 700 ends.

As mentioned above, the disclosed subject matter does not limit where different stages of method 300, 500 and/or 700 described herein take place. Depending on the embodiment, various stages of method 300, 500 and/or 700 described herein may take place at the receiving system 120, external service system 150, message managing system 140, and/or elsewhere in network 100. For instance, some of the possible examples include indication establishing taking place at receiving system 120, message managing system 140 and/or at one or more external service system(s) 150; validating taking place at receiving system 120, at one or more external service system(s) 150 and/or at message managing system 140; and/or indication providing taking place at receiving system 120, at one or more external service system(s) 150, and/or at message managing system 140.

Depending on the embodiment, it is possible that at least part of method 300 occurs prior to methods 500 and/or 700, and/or it is possible that at least part of method 300 occurs at the same time as method 500 and/or 700. For instance, assume that a suitable indication or negative indication basis has not been established prior to performing method 500 and/or 700. In this instance, method 300 may be performed as needed at the same time as method 500 and/or 700 in order to establish the basis. In some cases of this instance, no basis may have been previously established for the receiver, whereas in other cases of this instance a basis may have been previously established for the receiver which is not suitable for the current message. As an example of the latter cases, a basis may have been established for certain situation (s) such as certain sender(s), sender group(s), user device(s), geographic location(s) of sender(s), geographic location(s) of receiver(s), message characteristic(s) and/or receiving application(s), etc., but the basis may not be suitable (i.e. may not be used as is, nor may it be tailored) for the situation of the current message (e.g. for the sender, sender group, user device, geographic location of sender, geographic location of receiver, message characteristic(s), and/or receiving application, etc. of the current message). It may be assumed in this example, that it is desirable to establish a suitable basis, and therefore part or all of method 300 may be executed prior to outputting the indication or negative indication.

It will also be understood that in some embodiments a system or part of a system according to the presently disclosed subject matter may be a suitably programmed machine. Likewise, some embodiments of the presently disclosed subject matter contemplate a computer program being readable by a machine for executing a method of the presently disclosed subject matter. Some embodiments of the presently disclosed subject matter further contemplate a machine-useable medium tangibly embodying program code readable by the machine for executing a method of the presently disclosed subject matter.

While the presently disclosed subject matter has been shown and described with respect to particular embodiments, it is not thus limited. Numerous modifications, changes and improvements within the scope of the presently disclosed subject matter will now occur to the reader.

1. A method of providing an indication that a sender has been validated, comprising: if a sender of a message has been validated, outputting to a receiver of said message a receiver specific indication of validation, wherein data regarding said receiver specific indication was selected prior to said outputting, said selected data including data associated with said receiver on a website of said sender.

2. The method of claim 1, wherein said receiver specific indication is presented within an area where said message is being presented.

3. The method of claim 1, wherein said receiver specific indication is presented adjacent to an area where said message is being presented.

4. The method of claim 1, wherein said receiver specific indication is presented outside of an area where said message is being presented.

5. The method of claim 1, wherein said receiver specific indication is presented in a message list area.

6. The method of claim 1, wherein at least part of said receiver specific indication is outputted after said receiver places a mouse over a GUT element.

7. The method of claim 1, wherein at least part of said receiver specific indication is outputted after said receiver clicks on a GUI element.

8. The method of claim 1, wherein at least part of said selected data was selected automatically.

9. The method of claim 1, wherein said receiver specific indication is also specific to said sender or to a group including said sender.

10. The method of claim 1, wherein said selected data was selected from among a plurality of data associated with said receiver on said website of said sender.

11. The method of claim 1, wherein said receiver specific indication is not known to said sender.

12. The method of claim 1, further comprising:
if said sender has instead not been validated, outputting to said receiver a negative indication, indicating non-validation.

13. A method of indicating a valid sender, comprising:
selecting data regarding a receiver specific indication for indicating a valid sender, wherein said selected data includes data that is associated with said receiver on a website of said sender;
storing a basis for said receiver specific indication;
after a message has been sent by said sender to said receiver, validating said sender; and
outputting to said receiver said receiver specific indication.

14. The method of claim 13, wherein said receiver specific indication is identical to said basis.

15. The method of claim 13, further comprising: deriving said receiver specific indication, wherein said deriving includes: tailoring said basis to at least one selected from a group comprising: sender, sender group, message characteristic, geographic location of sender, geographic location of receiver, receiving user device, or receiving application.

16. The method of claim 13, further comprising: deriving said receiver specific indication, wherein said deriving includes: adding at least one generic element.

17. The method of claim 13, wherein said receiver specific indication is not known to said sender.

18. The method of claim 13, wherein at least part of said selected data is selected automatically.

19. The method of claim 13, further comprising: providing notification of validation.

20. The method of claim 19, wherein said notification is provided as part of said message.

21. A method of providing an indication that a sender has not been validated, comprising:
if a sender of a message has not been validated, outputting to a receiver of said message a receiver specific negative indication, indicating non-validation.

22. The method of claim 21, wherein said receiver specific negative indication is presented in at least one of the following: within an area where said message is being presented, adjacent to an area where said message is being presented, outside of an area where said message is being presented, or in a message list area.

23. The method of claim 21, wherein at least part of said receiver specific negative indication is outputted after said receiver places a mouse over a GUI element, or after said receiver clicks on a GUI element.

24. The method of claim 21, wherein prior to said outputting, at least one of the following is provided
input received from said receiver regarding said receiver specific negative indication, or
data automatically selected regarding said receiver specific negative indication.

25. The method of claim 21, wherein said receiver specific negative indication is not known to said sender.

26. An indication provider system, comprising:
at least one indication provision handler operable to cause a receiver specific indication of validation to be provided to a receiver of a message if a sender of said message has been validated;
wherein data regarding said receiver specific indication was previously selected, said selected data including data associated with said receiver on a website of said sender.

27. The system of claim 26, wherein said system includes at least one of said at least one indication provision handler, said system being an external service system.

28. The system of claim 26, wherein said system includes at least one of said at least one indication provision handler, said system being a message managing system operable to provide web-based message management to a plurality of users including said receiver.

29. The system of claim 26, wherein said system includes at least one of said at least one indication provision handler, said system being a receiving system which further comprises: a user output operable to output said receiver specific indication to said receiver.

30. The system of claim 29, wherein said output is operable to output at least part of said receiver specific indication when said receiver places a mouse over a GUI element.

31. The system of claim 29, wherein said output is operable to output at least part of said receiver specific indication when said receiver clicks on a GUI element.

32. The system of claim 26, wherein at least one of said at least one indication provider handler is operable to cause said receiver specific indication to be presented in an area where said message is being presented.

33. The system of claim 26, wherein at least one of said at least one indication provider handler is operable to cause said receiver specific indication to be presented adjacent to an area where said message is being presented.

34. The system of claim 26, wherein at least one of said at least one indication provider handler is operable to cause said receiver specific indication to be presented outside of an area where said message is being presented.

35. The system of claim 26, wherein at least one of said at least one indication provider handler is operable to cause said receiver specific indication to be presented in a message list area.

36. An indication basis establisher system, comprising:
at least one indication handler operable to automatically select, or receive, selected data regarding a receiver specific indication that a sender has been validated, wherein said selected data includes data that is associated with said receiver on a website of said sender, and operable to establish a basis for said receiver specific indication.

37. The system of claim 36, wherein said system includes at least one of said at least one indication handler, said system being a user device associated with said receiver.

38. The system of claim 36, wherein said system includes at least one of said at least one indication handler, said system being an external service system.

39. The system of claim 36, wherein said system includes at least one of said at least one indication handler, said system being a message managing system operable to provide web-based message management to a plurality of users including said receiver.

40. A computer program product comprising a computer useable medium having computer readable program code embodied therein for providing an indication that a sender has been validated, the computer program product comprising:
computer readable program code for causing the computer, if a sender of a message has been validated, to output to a receiver of said message a receiver specific indication of validation, wherein data regarding said receiver specific indication was selected prior to said output, said selected data including data associated with said receiver on a website of said sender.

41. A computer program product comprising a computer useable medium having computer readable program code embodied therein for indicating a valid sender, the computer program product comprising:
computer readable program code for causing the computer to automatically select, or receive, selected data regarding a receiver specific indication for indicating a valid sender, wherein said selected data includes data that is associated with said receiver on a website of said sender;
computer readable program code for causing the computer to store a basis for said receiver specific indication;
computer readable program code for causing the computer, after a message has been sent by said sender to said receiver, to validate said sender; and
computer readable program code for causing the computer to output to said receiver said receiver specific indication.

42. A computer program product comprising a computer useable medium having computer readable program code embodied therein for providing an indication that a sender has not been validated, the computer program product comprising:
computer readable program code for causing the computer, if a sender of a message has not been validated, to output to a receiver of said message a receiver specific negative indication, indicating non-validation.
